(19) United States
(12) Patent Application Publication
(10) Pub. No.: US 2021/0357865 A1
(43) Pub. Date: Nov. 18, 2021

(54) EVENT-BASED TIMELINE CREATION FOR PERSONAL INFORMATION TRACKING

(71) Applicant: ZenPayroll, Inc., San Francisco, CA (US)

(72) Inventors: Irandi Upeka Bulumulla, San Francisco, CA (US); Ketki Warudkar Duvvuru, Mountain View, CA (US); Bria Nicole Fincher, Oakland, CA (US); David Charles Haley, Oakland, CA (US); Ryan Kwong, San Francisco, CA (US); Ningjing Su, San Francisco, CA (US); Michael Kelly Sutton, San Francisco, CA (US); Matan Zruya, San Francisco, CA (US)

(21) Appl. No.: 15/930,161

(22) Filed: May 12, 2020

(51) Int. Cl. G06Q 10/10; G06Q 10/06; G06Q 40/00; G06Q 50/26; G06Q 40/02; G06F 16/23; G06F 9/451

(52) U.S. Cl. CPC G06Q 10/105; G06Q 10/0635; G06Q 40/10; G06Q 50/26; G06F 9/451; G06Q 40/02; G06Q 10/06312; G06F 16/23; G06Q 40/125

(57) ABSTRACT

A database management engine allows users to easily and automatically make retroactive modifications to database entries in a human resource database. The database management engine captures events associated with the retroactive modifications through the continuous construction of event timelines, which provide an up-to-date picture of liabilities and penalties owed. Through the continuous construction of event timelines, the database management engine can identify discrepancies between previously generated timelines and new timelines. Further, the database management engine can identify appropriate remedial actions based on the characteristics of the discrepancies. In addition, by continuously generating additional timelines, the database management engine allows users to modify database entries without removing information from the human resource database.

### BACKGROUND

This description generally relates to human resource database systems and specifically to identifying potential penalties and liabilities based on retroactive modifications to a human resource database.

In current human resource database systems, employee liabilities associated with a compensation period are often computed once using employee data. These liabilities reflect the state of the employee's data at the time of computation, such as the filing status, location, title, etc., of the employee. When employee data is retroactively modified, previously computed liabilities may no longer be accurate. However, current human resource database systems often do not have mechanisms to efficiently catch and correct these inaccuracies. Inaccurate computations can lead to penalties and downstream liability changes that can affect both the employee and additional entities associated with the employee, such as employers, government agencies, investors, and the like. Further, data modifications may result in additional liabilities and penalties. Current human resource database systems are often not equipped to identify these additional liabilities and penalties.

### SUMMARY

A database management engine allows users to easily and automatically make retroactive modifications to database entries in a human resource database. The database management engine captures events associated with the retroactive modifications through the continuous construction of event timelines, which provide an up-to-date picture of liabilities and penalties owed. Through the continuous construction of event timelines, the database management engine can identify discrepancies between amounts owed and amounts paid. For example, the database management engine may identify that a first jurisdiction is owed additional funds in response to a backdated tax rate change. Further, the database management engine can identify appropriate remedial actions based on the characteristics of the discrepancies, such as the amount owed, parties involved, deadlines, and the like. In addition, by continuously generating additional timelines, the database management engine allows users to modify database entries without removing information from the human resource database.

Timelines may be generated at a predetermined frequency, such as every week, every other week, every month, every quarter, and the like. Additionally, and/or alternatively, the database management engine may generate a new timeline each time a database entry is modified. For example, the database management engine may receive a request from a user to retroactively modify data in an employee entry of a human resource database. Modifications may include a change of address, a change of salary, a change of filing status, a change of local tax laws, a change of state tax laws, a change in federal tax laws, a change in benefits, a tax rate recalculation, a bonus, and the like.

In response, a previously generated timeline of the employee is accessed. The previously generated timeline includes liability events that occurred during a period of time and was generated using data in the entry of the human resource database before the data is modified. The database management engine may identify modified data to replace the data in the database entry based on the request from the user. The database management engine may identify one or more liability events associated with the modified data. For example, if the data modification includes an address change, the database management engine may identify a relocation event. The database management engine generates an additional timeline for the same or similar period of time using the identified one or more liability events and the liability events associated with the previously generated timeline. The database management engine may then use the additional timeline to determine how the set of liability events associated with the additional timeline affects the employee's liabilities. Further, the database management engine 115 may identify penalties and/or interests associated with the retroactive modification. The previously generated timeline and the additional timeline are provided for display on a user interface. The user interface also includes an interface element that, when selected by the user, replaces the data in the entry of the database with the modified data. In some embodiments, a differential timeline representing a difference between the liability events associated with the previously generated timeline and the additional timeline generated is provided for display. Additionally, information detailing the differences in liability events may also be provided for display. Information may include amounts owed (e.g., liabilities, penalties, debits, credits), parties involves, reasons for differences in liability events, and the like.

The database management engine may identify one or more remedial actions to perform based on the difference in timeline events and their corresponding characteristics. Users may be required to explicitly confirm the identified remedial actions before they are performed by the database management engine. Remedial actions may include allocating debits or credits to affected entities, such as government agencies, employees, employers, the like. Additionally, users may be required to select how remedial actions are performed. For example, users may be required to select how debits and credits are allocated, e.g., by extracting funds from a current pay stub, extracting funds from one or more future pay stubs, issuing a remedial pay stub, issuing and/or filing a settlement, and the like.

### BRIEF DESCRIPTION OF THE DRAWINGS

FIG. 1 illustrates a diagram of a system environment of a database management engine, according to one embodiment.

FIG. 2 illustrates a block diagram of the database management engine, according to one embodiment.

FIG. 3 illustrates an example user interface of the database management engine, according to one embodiment.

FIG. 4 illustrates an example process of generating a new timeline, according to one embodiment.

FIG. 5 is a flowchart of a method for generating a timeline, according to one embodiment.

The figures depict various example embodiments of the present technology for purposes of illustration only. One skilled in the art will readily recognize from the following description that other alternative embodiments of the structures and methods illustrated herein may be employed without departing from the principles of the technology described herein.

### DETAILED DESCRIPTION

### System Overview

FIG. 1 illustrates a diagram of a system environment 100 of a database management engine 115, according to one embodiment. The system environment 100 shown by FIG. 1 includes a user 105, a client device 110, a database management engine 115, and a database 120. In alternative configurations, different and/or additional components may be included in the system environment 100.

A user 105 of the database management engine 115 is an individual or entity associated with an organization. Organizations may include schools or universities, businesses, non-profits, government agencies, and the like. Each organization has one or more employees. A user 105 can use the database management engine 115 to manage employee information, in particular payroll and tax-related information.

The client devices 110 are one or more computing devices capable of receiving user input as well as transmitting and/or receiving data via a network. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via a network. In one embodiment, a client device 110 executes an application allowing a user of the client device 110 to interact with the database management engine 115. For example, a client device 110 executes a browser application or native application to enable interaction between the client device 110 and the database management engine 115 via a network. In another embodiment, a client device 110 interacts with the database management engine 115 through an application programming interface (API) running on a native operating system of the client device 110, such as IOS® or ANDROID™.

The client devices 110 are configured to communicate via a network, which may include any combination of local area and/or wide area networks, using both wired and/or wireless communication systems. In one embodiment, a network uses standard communications technologies and/or protocols. For example, a network includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network may be represented using any suitable format, such as hypertext markup language (HTML) or extensible markup language (XML). In some embodiments, all or some of the communication links of a network may be encrypted using any suitable techniques.

The database management engine 115 enables a user 105 to manage information of employees and/or other personnel or individuals associated with an organization. For instance, the database management engine 115 enables a user 105 to amend and update employee information stored by the database 120, run and configure payrolls, and generate tax tables for individuals and/or organizations, and the like. A user 105 may access and modify data stored in the database 120 through an interface populated by the database management engine 115 and displayed by a client device 110. The database management engine 115 is described in detail below.

Each employee of an organization is associated with an entry in the database 120. A user 105 creates and modifies database entries of the database 120 using the database management engine 115. A database entry includes declarative information about the employee that was provided by the employee, for instance at the time of hiring the employee, by the employer, and/or other personnel associated with the organization. Each database entry includes multiple data fields, each describing one or more attributes of the corresponding employee. Examples of information stored in a database entry include (but are not limited to) biographic information, demographic information, geographic information (such as state of employment and/or home address), payroll history, and other types of descriptive information, such as information related to tax filings (e.g., salary, employer, citizenship status, number of dependents, work location, deductions, and the like). In some embodiments, database entries also include documents filled-in by the employee or on behalf of the employee, such as documents related to benefits selections, tax filings, equity, etc. In some embodiments, a database entry in the database 120 may also maintain references to actions made to the corresponding database entry. For example, the database entry may include a log of changes made to a database entry, including changes to payroll, workplace location, citizenship, and corresponding metadata (e.g., time, date, location, author, etc.).

In some embodiments, the database 120 also includes database entries for the organization itself. Data stored in an organization's database entry may include payroll history, number of employees, location of company holdings, benefits provided to each employee (health care, retirement plans, equity, etc.), company or partnership tax liabilities, and the like. The database 120 may also include information about organizational preferences and security settings. For example, an organization's database entry may include data fields corresponding to payroll frequency, when database modifications can be made to database entries, who can modify database entries, when bonuses are given and/or received, when benefit enrollment periods are open, when employees can apply for relocation, and the like.

### Data Management Engine

The database management engine 115 manages database entries in the database 120. In particular, the database management engine 115 generates and maintains timelines of employees, employers, and organizations associated with database entries. A timeline delineates liability events that have occurred during a predetermined period of time. Liability events may include, but are not limited to, relocations, title changes, filing status changes, benefit changes, and the like. Liability events associated with a timeline are correlated with payroll events to compute liabilities, penalties, credits, debits, etc., owed by a corresponding employee and/or employer during one or more pay periods. Payroll events are events in which liabilities, penalties, credits, debits, etc., are computed for an employee, employer, and/or organization. Examples of payroll events include, but are not limited to, payrolls, bonuses, reimbursements, and the like. For example, when running a payroll, the database management engine 115 may use employee timelines to calculate estimated liabilities owed by each employee during the corresponding pay period. In some embodiments, timelines include payroll events occurring during the predetermined period of time. Alternatively, or additionally, the database management engine 115 may generate and maintain additional timelines that delineate payroll events occurring over the same or similar periods of time.

Further, the database management engine 115 may use timelines to generate tax tables for employees, employers, and/or organizations. Using the generated tax tables, users of the database management engine 115 can identify which liability event, employee, employer, etc., contributed to changes in payroll system activities. The database management engine 115 may provide one or more timelines for display on a user interface. In providing the timelines for display, the database management engine 115 may also provide information detailing the events of the timeline, which attributes were used to generate the timeline, which liabilities, penalties, and/or interests are associated with each timeline event, when the timeline was generated, and the like.

The database management engine 115 may continuously generate new timelines for employees, employers, and/or organizations at a predetermined frequency (e.g., every pay period, every month, every quarter, etc.). Additionally, and/or alternatively, the database management engine 115 may generate a new timeline when a database entry is modified to capture all liability events associated with the modification and all payroll events affected with the modification. Examples of modifications that may affect payroll events include address changes, hours changes, position changes, filing status changes, benefits election changes, company size changes, company changes (e.g., switching between companies that both use the database management engine 115), and the like. Similarly, the database management engine 115 may generate new timelines when external factors that affect payroll events are modified, such as changes in tax laws, liability software updates, and the like. Multiple timelines associated with a single person and/or organization may be compared to identify changes in timeline events that have occurred over the periods associated with each of the timelines.

The database management engine 115 may also identify discrepancies in timelines by comparing multiple timelines associated with an individual that cover the same period. For example, the database management engine 115 may identify discrepancies by comparing the timeline generated with an original configuration of liability events (i.e., before a database entry is modified) and an updated timeline generated with the updated configuration of liability events (i.e., after the database entry is modified). Discrepancies may occur when factors and/or attributes affecting payroll events are retroactively modified, and may include a net amount of liabilities and/or penalties owed to one or more jurisdictions, debits and/or credits owed to an employee or employer, and the like. Retroactive modifications to database entries may include reversing and rerunning payrolls, rate changes, title changes, salary changes, bonuses, address changes, exemption changes, unreported hirings, unreported terminations, benefits elections changes (e.g., changes that occur at the end of an open enrollment period), and the like. Additional factors that may be retroactively modified include software updates to fix computational errors, retroactive changes in tax rates, and the like.

In some embodiments, the discrepancies are provided on a user interface of the database management engine 115 as a differential timeline. The differential timeline includes the liability events that are associated with the updated configuration but were not included in the original configuration of liability events. The differential timeline may also indicate which liability were included in the original configuration of liability events but are no longer relevant in view of the updated configuration of liability events. For example, the differential timeline may indicate that an overtime payroll event is no longer applicable in view of a corresponding employee changing from a position with an hourly compensation scale to a position with a salaried compensation scale. The database management engine 115 may also provide information detailing the discrepancies, such as differences in liability events associated with each timeline, corresponding differences in payroll events, reasons for the discrepancies, and the like. In some embodiments, the differential timeline includes the information detailing the discrepancies with each liability event of the differential timeline. For example, if a differential timeline includes a promotion event, the promotion event may include information indicating an amount of liabilities owed to one or more jurisdictions based on the employee's increased compensation, an amount of compensation owed to the employee for being underpaid during one or more payrolls, relevant penalties and/interests owed, and the like.

The database management engine 115 may identify one or more remedial actions that may be performed to amend the identified discrepancies based on tax law, the magnitude of the discrepancy, parties involved (e.g., external versus internal entities), and/or and user preferences. Remedial actions may include running a remedial payroll, filing/issuing a settlement, extracting funds from a current paystub of an employee, allocating funds to new tax jurisdictions, requesting tax refunds for tax overpayments, issuing a correction pay stub at an end of a pay period, incorporating owed funds into a next pay period, distributing owed funds over multiple pay periods, and the like. Remedial actions may also include inaction. For example, if an amount owed to an agency is less than a threshold amount (e.g., less than $1 USD), the agency may not require compensation for monies owed. Further, remedial actions may also include preparing relevant agency forms, such as new state registrations, updated tax forms, and the like. The database management engine 115 may recommend the identified remedial actions to a user 105 on a user interface of the database management engine 115. In some embodiments, the database management system 115 requests explicit confirmation from the user 105 before performing the identified remedial actions.

As an example, a user 105 may enter a backdated address for an employee that transferred from a company's California office to its Washington office between a first and second payroll of a previous financial quarter. If the previous financial quarter is closed, when the database modification is made, the timeline of the employee, T1, and the quarter's filings will no longer be accurate. In this example, the timeline of the employee, T1, does not include the relocation event, and the filing does not account for the taxes owed to Washington and the taxes overpaid to California in the second payroll of the previous financial quarter. In response to the modification, the database management engine 115 generates a second timeline of the employee, T2, that includes the address change at the time the address change occurred and corresponding payroll activities. Based on a comparison of T1 and T2, the database management engine 115 may identify the nature of the differences between the two timelines and remedial actions that need to be performed to reconcile the differences. In this example, the remedial actions may include running a payroll amendment that includes the amount taxes owed to Washington, the refund owed to the employee and/or employer for overpaying taxes in California, and any penalties and interests owed for not filing the address change on-time. Remedial actions may also include filing Washington state registrations and updated tax forms. The timelines and remedial actions may be provided to the user 105 on a user interface.

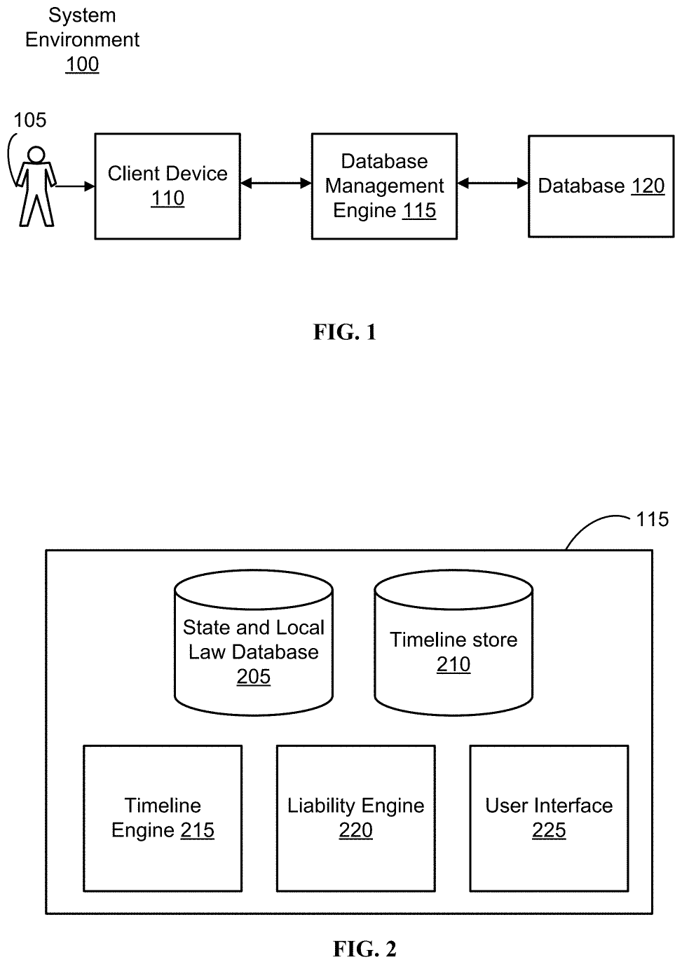

FIG. 2 is a block diagram of an architecture of the database management engine 115, according to one embodiment. The database management engine 115 shown in FIG. 2 includes a state and local law database 205, a timeline store 210, a timeline engine 215, a liability engine 220, and a user interface 225. In other embodiments, the database management engine 115 may include additional, fewer, or different components for various applications. Conventional components such as security functions, load balancers, failover servers, management and network operations consoles, and the like are not shown so as to not obscure the details of the system architecture.

The state and local law database 205 stores federal, state, and/or local tax laws of each jurisdiction associated with an organization or employee of the organization, such as states of incorporation, office locations, home address locations, and the like. Tax laws may include, but are not limited to, available tax deductions, available tax refunds, and tax rates/tax brackets of various jurisdictions. The state and local law database 205 may be connected to a network to import tax laws from third-party software systems, third-party databases, and the like. The state and local law database 205 may be automatically updated when new tax laws are put into effect or existing tax laws are amended. The state and local law database 205 may also be updated at a frequency set by the user 105 (e.g., every month, quarter, year, etc.) or by a trigger event (such as a request from the user 105, a database administrator, running payroll, and the like). In some embodiments, the state and local law database 205 includes other laws that are used to identify and calculate liabilities. The state and local law database 205 may also store forms relevant to requisite remedial actions identified by the database management engine 115. For example, the state and local law database 205 may store templates of new state registration forms, tax amendment forms, tax return forms, and the like.

The timeline store 210 maintains timelines generated by the timeline engine 215. As previously discussed, a timeline delineates liability events that have occurred during a predetermined period of time. A timeline may also include the payroll events that occurred during the period of time. The timeline store 210 may store information detailing the liability events of the timeline, corresponding payroll events, which attributes were used to generate the timeline, which liabilities and penalties are associated with each timeline event, when the timeline was generated, and the like. The timeline store 210 may also store differential timelines that include the differences in two or more timelines computed for the same entity (e.g., employee, employer, and/or organization) during a same or similar period of time. The timeline store 210 may also store information detailing the differential timelines, such as the differences in timeline events, differences in payroll system activities, reasons for the differences, and the like. The timeline store 210 may also store information about the remedial actions performed and/or recommended to a user based on the differences in timeline events.

The timeline engine 215 generates timelines of liability events for employees, employers, and/or organizations. The timeline engine 215 identifies liability events using the set of attributes stored in database entries of the database 120. The set of attributes reflect the assumed state of the corresponding employee, employer, and/or organization during timeline generation (e.g., the location, filing status, position, etc., of the employee, employer, or organization). For example, if the set of attributes includes a new address, the timeline engine 215 includes a relocation event in the timeline. In some embodiments, the timeline engine 215 includes payroll events in the timelines. The timeline engine 215 may correlate liability events with payroll events to identify which payroll events are affected by one or more liability events. For example, if a relocation event occurs before a payroll event, the timeline engine 215 may correlate the relocation event with the payroll event because the liabilities and net compensation associated with the payroll event may be affected by the relocation event (e.g., due to changes in state tax rates, relocation packages, and the like). The timeline engine 215 may generate new timelines at a predetermined frequency, such at every pay period, every month, every quarter, every year, and the like. Additionally, and/or alternatively, the database management engine 115 may generate new timelines when the database is modified, when a payroll event occurs, and the like. Database modifications may include modifications made to individual database entries, a set of database entries, system preferences, tax laws, and the like. The periods covered by new timelines may begin on the same date such that all payroll events affected by the database modification may be identified and reconciled. The periods covered by the new timelines may end on the same date, on the date the new timeline is generated, on the date associated with the data modification, and the like. The timeline engine 215 may identify differences between liability events and payroll events in previously generated timelines and new timelines. This ensures that liabilities and penalties resulting from retroactive modifications are identified and reconciled.

The liability engine 220 computes liabilities and penalties associated with the liability events and payroll events identified by the timeline engine 215. Liabilities and penalties may be associated with a database entry of an employee, an employer, an organization, or a combination thereof. In addition, the liability engine 220 identifies necessary remedial actions based on differences in timelines generated by the timeline engine 215. Remedial actions may be necessary to reconcile previously-run payrolls, true-up taxes owed/overpaid by the organization or employee, debit penalties and interests owed for backdated database modifications, and the like. In some embodiments, the liability engine 215 also identifies tax exemptions, deductions, rebates, etc., available to the organization or employee. For example, the liability engine 215 may identify a tax exemption an employee qualifies for in response to a database modification, e.g., in response to an address or position change.

To compute the projected liabilities and penalties, identify available tax credits and refunds, and/or identify necessary remedial actions, the liability engine 220 queries the state and local law database 205 using information associated with the database modification (e.g., such as an employee's old address and new address). A combination of the liabilities, penalties, tax credits, refunds, and requisite remedial actions associated with the modified database entry are displayed to the user 105 on the user interface 225. In some embodiments, the liabilities, penalties, net compensation, tax credits, and/or refunds associated with each liability event and payroll events are displayed on the timeline. Additionally, the liability engine 220 may display information detailing which liability events and payroll events are correlated, the effect a liability event has on a payroll event, and the like.

The user interface 225 allows a user 105 to access, modify, and create database entries in the database 120 using various elements of the user interface 225. In some embodiments, to modify a database entry in the database 120, a user 105 must view the projected liabilities, penalties, and requisite payroll amendments resulting from the requested database modification. In these embodiments, the user may be required to explicitly confirm the database modification. For example, the user 105 may have to trigger a user command, provide security information (e.g., a pin number, passcode, etc.), etc., before the database modification and payroll amendments are entered. The user interface 225 also allows users to view timelines generated by the timeline engine 215, set preferences for timeline generation (e.g., set a frequency, period), and the like. Further, the user interface 225 allows a user 105 to view and accept liabilities and penalties, and to perform remedial actions identified by the liability engine 220. In some embodiments, before the database management engine 115 performs a requisite remedial action, the user must explicitly confirm the action using an interactive element of the user interface 225.

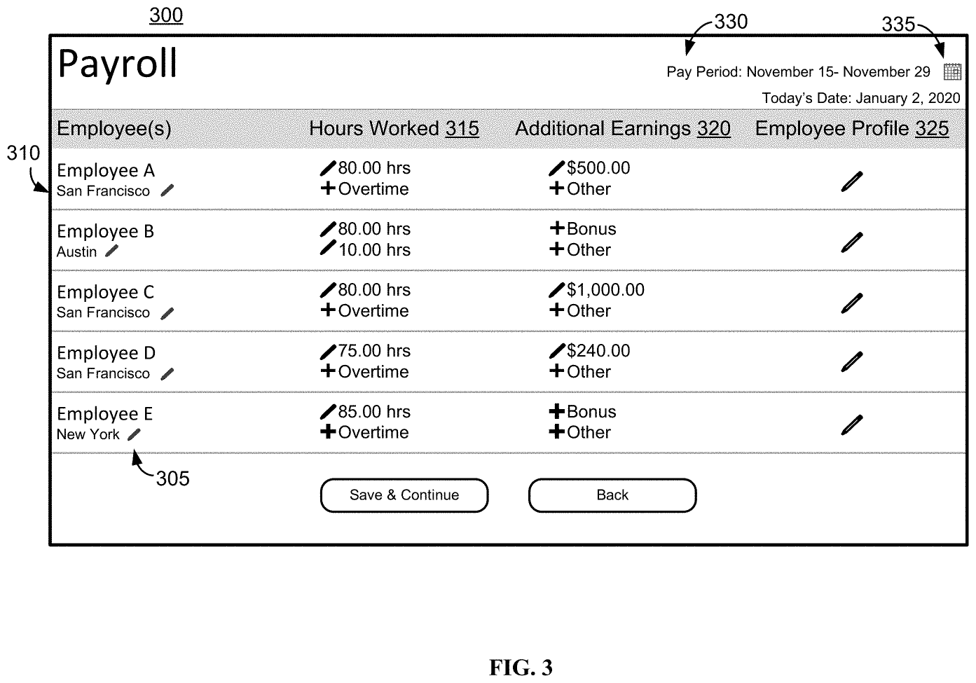

FIG. 3 illustrates an example user interface 300 of the database management engine 115, according to one embodiment. The user interface 300 may be provided to a user 105 before the user 105 runs a payroll event, such as bi-weekly payroll, bonus payroll, reimbursement payroll, and the like. The user interface 300 includes interactive interface elements, such as element 305, that allow the user 105 to modify data that is used by the database management engine 115 to compute liabilities and penalties associated with the payroll event. Data includes, but is not limited to, employee location 310, hours worked 315, and additional earnings 320. The user 105 may also modify additional data in an employee profile 325.

The user 105 may also access the user interface 300 to retroactively modify data associated with pay periods that have already occurred. The user 105 may do this by selecting a pay period 330 using an interactive interface element, such as the calendar icon 335. When the user 105 retroactively modifies data associated with a pay period 330, the timeline engine 215 identifies liability events associated with the modification. The timeline engine 215 also correlates payroll events that occurred during the pay period 330 with the identified liability events. In addition, the timeline engine 215 identifies all downstream payroll events that be affected by the identified liability events. For example, if, in a third financial quarter, a user 105 retroactively modifies data in a first financial quarter, the timeline engine 215 identifies all payroll events that occurred during the first, second, and third financial quarters. Additionally, the modified data will be used when additional timelines are generated in the fourth financial quarter.

The timeline engine 215 constructs a new timeline using the liability events associated with a previously generated timeline, liability events identified based on the data modification, and payroll events occurring in the period covered by the timeline. Using the new timeline, the liability engine 220 computes the liabilities associated with the liability events and payroll events. The liability engine 220 may compare liabilities associated with the new timeline and previously generated timeline to determine net liabilities, penalties, and/or interests owed. The liability engine 220 may also identify one or more requisite remedial actions to perform to reconcile the net liability, penalties, and/or interests owed.

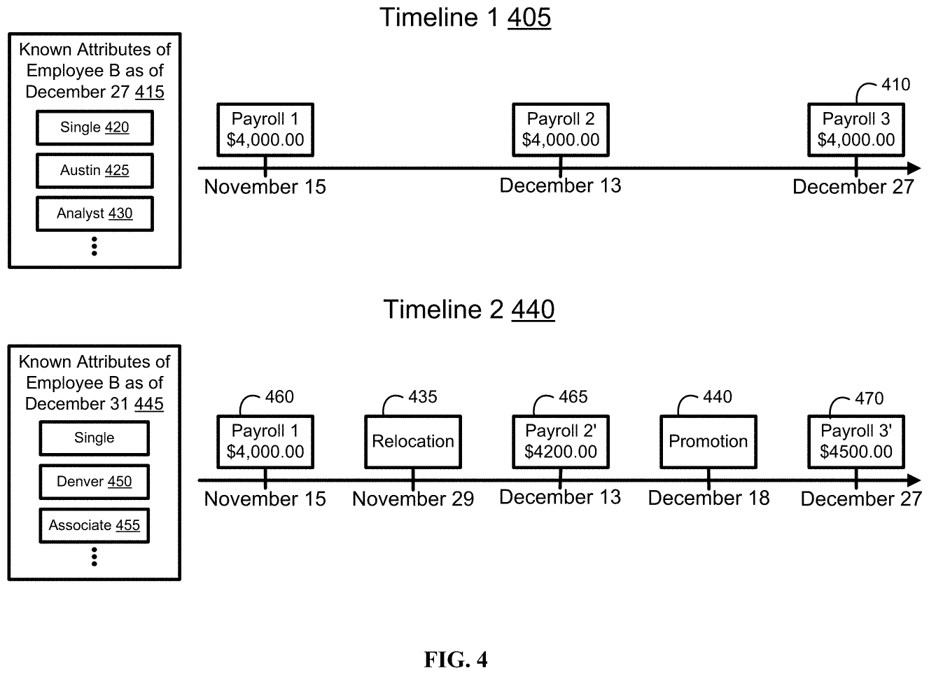

FIG. 4 illustrates an example process of generating a new timeline, according to one embodiment. As previously discussed, liabilities associated with a payroll event and owed by an individual or entity are identified using a set of attributes that represent the individual's or entity's assumed state at the time of the payroll event. The assumed state of an individual or entity may be affected by liabilities events, such as relocation events and position changes. Therefore, liability events may also affect the liabilities owed by the individual or entity during one or more payroll events. To maintain an accurate picture of the liabilities, penalties, credits, and/or debits, owed by or to an individual or entity, the database management engine 115 continuously generates new timelines to reflect changes in the individual's or entity's assumed state. This is particularly useful when the set of attributes that represent an individual's state are retroactively modified, as illustrated in FIG. 4.

FIG. 4 illustrates a portion of a first timeline, timeline 1 405, that was generated for Employee B on the date of a payroll event, namely payroll 3 410. The portion of timeline 1 405 shown includes three payroll events, and displays a net amount of compensation associated with each of the payroll events. Timeline 1 405 was generated using the known attributes of Employee B as of December 27 415, the date of payroll 3 410. As of December 27, it was assumed that Employee B was filing singly 420, lived in Austin, Tex. 425, and was an analyst 430 during each of the three payroll events. As a result, the liabilities owed and net compensation received by Employee B during each of the three payroll events remained constant.

However, a user 105 of the database management engine 115 may retroactively modify the set of attributes of Employee B. As shown in FIG. 4, modifications are retroactively made on December 31 and are associated with two liability events, namely a relocation event 435 that occurred on November 29 and a promotion event 440 that occurred on December 18. The known attributes of Employee B as of December 31 445 now indicate that Employee B lives in Denver, Colo. 450 and is an associate 465. Using the known attributes of Employee B as of December 31 445 and the corresponding liability events, the database management engine 115 generates a new timeline, namely timeline 2 440, that captures the liability events and their effect on the three payroll events, payroll event 1 460, payroll event 2′ 465, and payroll event 3′ 470.

Since neither liability event occurred before the date of the first payroll event, the liabilities owed and net compensation of payroll 1 460 in timeline 2 440 is the same as the net compensation associated with payroll 1 in timeline 1 405. In contrast, the relocation event 435 affects the second and third payroll events, and the promotion event 440 affects the third payroll event. In the example shown, the liabilities owed during payroll 2′ 465 and payroll 3′ 470 decreased after the relocation event 435. This may be a result of tax rate differences between Austin 425 and Denver 450. The net compensation owed to Employee B increased further during payroll 3′ 470 as a result of the promotion event 18 440 that occurred on December 18 when Employee B was promoted from an analyst 430 to an associate 455.

The database management engine 115 can compare timeline 1 405 and timeline 2 440 to identify discrepancies between liabilities owed and liabilities paid by Employee B. The database management engine 115 may also compares the timelines to identify which liability events affected which payroll events, changes in liabilities associated with each payroll event, and the like. The differences in liabilities owed and liabilities paid may be reconciled by the database management engine 115 through one or more remedial actions. Remedial actions may include refunding Employee B for overpaying taxes in Texas, debiting Employee B for liabilities owed in Colorado, filing Colorado state registrations, reconciling penalties and interests owed for not filing the address change on time, crediting Employee B based on her promotion, and the like. Further, the user who made the retroactive modification and/or personnel of the employer of Employee B, may select how the remedial actions are performed. In addition, tax laws associated with affected jurisdictions may guide how and what remedial actions are performed. For example, some jurisdictions may require that all funds owed are paid by the end of a financial quarter, and other jurisdictions may not allow funds to be reconciled until the end of a calendar year.

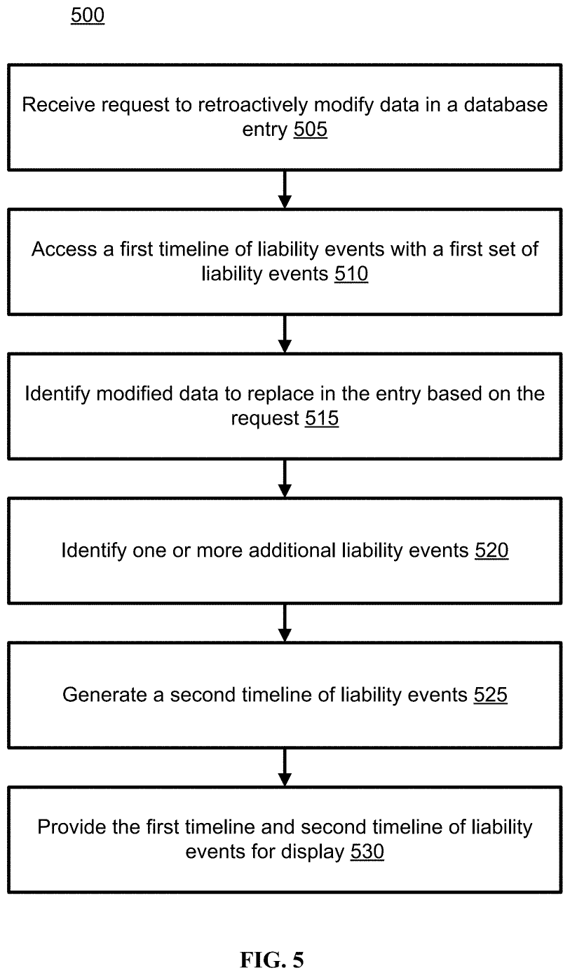

FIG. 5 is a flowchart of a method 500 for generating a timeline in response to receiving a request to modify a database entry, according to one embodiment. In the method 500 shown, a request to retroactively modify data in a first entry of a database is received 505. As previously discussed, the database contains a plurality of entries each corresponding to an employee and including data associated with the employee. A first timeline of liability events is accessed 510. The first timeline of liability events is associated with the employee and includes a first set of liability events that occurred during a period of time.

Modified data to replace data in the entry is identified 515 based on the request. One or more additional liability events are identified 520 based on the modified data. For example, if the modification includes an address change, then a relocation event is identified. Similarly, if the modification includes a title change, then a promotion or demotion event is identified. A second timeline of liability events is generated 525 that includes a second set of liability events that occurred during the same or similar period of time. The second set of liability events includes one or more of the liability events of the first set of liability events and the one or more additional liability events associated with the modified data. For example, if an entry already includes a promotion event, and the user requests to enter a backdated address change, the second set of liability events will include the promotion event and the relocation event.

The first timeline of liability events and the second timeline of liability events are provided 530 for display on a user interface of a user device in combination an interface element that, when selected by the user, replaces the data in the first entry of the database with the modified data. The modified data is configured such that all payroll events, even those occurring on a date before the data is replaced, may be reconciled by the database management engine 115. For example, if data in the first entry is modified on February 7 to correct a benefits election change that occurred on December 15 of the previous year, the entry is modified in a way that indicates the benefits election change occurred on December 15. Therefore, all payroll events affected by the December 15 benefits election change are reconciled, not just those payroll events occurring on or after February 7.

In some embodiments, both the first and second timelines are displayed separately. In some embodiments, a differential timeline that represents the differences between the first timeline of liability of events and second timeline of liability events is also provided for display. In addition, payroll events, such as bi-weekly payrolls, bonus payrolls, reimbursement payrolls, corrective payrolls, etc., occurring during the period of time are also be provided for display. Payroll events may be displayed on the first timeline, second timeline, or a combination thereof. Alternatively, and/or additionally, payroll events may be displayed in a separate timeline.

The user interface may be modified to include an interface element detailing the liability events. Details may include tax liabilities, penalties, interests, credits, and/or debits associated with liability events in the second set of liability events, liability events in the first set of liability events, differences in the first set and second set of liability events, and the like. Details may also include which parties are affected by the liability events, which payroll events are affected by the liability events, and one or more remedial actions identified and recommended by the database management engine 115. The database management engine 115 may request explicit confirmation from the user before performing one or more of the identified remedial actions. Users may provide confirmation using one or more interactive elements of the user interface.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a request from a user to retroactively modify data in a first entry of a database, the database containing a plurality of entries each corresponding to an employee and including data associated with the employee;
accessing a first timeline of liability events associated with the employee, the first timeline of liability events comprising a first set of liability events that each occurred during a period of time;
identifying modified data to replace the data in the first entry of the database based on the request from the user;
identifying one or more additional liability events associated with the modified data;
generating a second timeline of liability events, the second timeline of liability events comprising a second set of liability events that occurred during the period of time, the second set of liability events including one or more of the first set of liability events and including the one or more additional liability events associated with the modified data; and
providing for display, on a user interface of a user device, the second timeline of liability events, the first timeline of liability events, and an interface element prompting a user to confirm the second timeline of liability events and that, when selected by the user, replaces the data in the first entry of the database with the modified data.

2. The method of claim 1, further comprising:
identifying one or more additional tax liabilities associated with a jurisdiction based on a difference between the first set of liability events and the second set of liability events; and
allocating one or more debits or credits in association with the jurisdiction based on the difference.

3. The method of claim 2, wherein allocating one or more debits or credits in association with the jurisdiction comprises one or more of: extracting funds from a current pay stub of the employee, extracting funds from one or more pay stubs of the employee, issuing a correction pay stub at an end of a pay period to the employees, and issuing a settlement.

4. The method of claim 1, further comprising:
generating a differential timeline, the differential timeline representing a difference between the first timeline of liability events and the second timeline of liability events; and
providing the differential timeline for display on a user interface of a user device of the user.

5. The method of claim 1, further comprising:
identifying one or more tax liabilities associated with the second set of liability events, each tax liability associated with an amount owed to a jurisdiction; and
redistributing funds allocated to each of the jurisdictions based on the one or more tax liabilities.

6. The method of claim 1, further comprising:
accessing an employer timeline of liability events, the employer timeline associated with an employer of the employee;
identifying one or more employer liability events based on the modified data; and
generating an updated employer timeline based on the employer timeline and the one or more employer liability events.

7. The method of claim 1, wherein the modification of the data includes one or more of: a change of address, a change of salary, a change of status, a change in local tax laws, a change in state tax laws, a change in federal tax laws, a change in benefits, a tax rate recalculation, and a bonus.

8. The method of claim 1, further comprising:
providing for display, on the user interface of the user device, a second interface element that, when selected, causes one or more remedial actions addressing the second set of liability events to be performed.

9. A non-transitory computer-readable storage medium containing computer program code that, when executed by a processor, causes the processor to perform steps comprising:
receiving a request from a user to retroactively modify data in a first entry of a database, the database containing a plurality of entries each corresponding to an employee and including data associated with the employee;
accessing a first timeline of liability events associated with the employee, the first timeline of liability events comprising a first set of liability events that each occurred during a period of time;
identifying modified data to replace the data in the first entry of the database based on the request from the user;
identifying one or more additional liability events associated with the modified data;
generating a second timeline of liability events, the second timeline of liability events comprising a second set of liability events that occurred during the period of time, the second set of liability events including one or more of the first set of liability events and including the one or more additional liability events associated with the modified data; and
providing for display, on a user interface of a user device, the second timeline of liability events, the first timeline of liability events, and an interface element prompting a user to confirm the second timeline of liability events and that, when selected by the user, replaces the data in the first entry of the database with the modified data.

10. The non-transitory computer-readable storage medium of claim 9, wherein the program code, when executed by the processor, causes the processor to perform further steps comprising:
identifying one or more additional tax liabilities associated with a jurisdiction based on a difference between the first set of liability events and the second set of liability events; and
allocating one or more debits or credits in association with the jurisdiction based on the difference.

11. The non-transitory computer-readable storage medium of claim 10, wherein allocating one or more debits or credits in association with the jurisdiction comprises one or more of: extracting funds from a current pay stub of the employee, extracting funds from one or more pay stubs of the employee, issuing a correction pay stub at an end of a pay period to the employees, and issuing a settlement.

12. The non-transitory computer-readable storage medium of claim 9, wherein the program code, when executed by the processor, causes the processor to perform further steps comprising:
generating a differential timeline, the differential timeline representing a difference between the first timeline of liability events and the second timeline of liability events; and
providing the differential timeline for display on a user interface of a user device of the user.

13. The non-transitory computer-readable storage medium of claim 9, wherein the program code, when executed by the processor, causes the processor to perform further steps comprising:
identifying one or more tax liabilities associated with the second set of liability events, each tax liability associated with an amount owed to a jurisdiction; and
redistributing funds allocated to each of the jurisdictions based on the one or more tax liabilities.

14. The non-transitory computer-readable storage medium of claim 9, wherein the program code, when executed by the processor, causes the processor to perform further steps comprising:
providing for display, on the user interface of the user device, a second interface element that, when selected, causes one or more remedial actions addressing the second set of liability events to be performed.

15. A system comprising:
a hardware processor; and
a non-transitory computer-readable medium containing instructions that, when executed by the hardware processor, cause the hardware processor to:
receive a request from a user to retroactively modify data in a first entry of a database, the database containing a plurality of entries each corresponding to an employee and including data associated with the employee;
access a first timeline of liability events associated with the employee, the first timeline of liability events comprising a first set of liability events that each occurred during a period of time;
identify modified data to replace the data in the first entry of the database based on the request from the user;
identify one or more additional liability events associated with the modified data;
generate a second timeline of liability events, the second timeline of liability events comprising a second set of liability events that occurred during the period of time, the second set of liability events including one or more of the first set of liability events and including the one or more additional liability events associated with the modified data; and
provide for display, on a user interface of a user device, the second timeline of liability events, the first timeline of liability events, and an interface element prompting a user to confirm the second timeline of liability events and that, when selected by the user, replaces the data in the first entry of the database with the modified data.

16. The system of claim 15, further containing instructions that cause the hardware processor to:
identify one or more additional tax liabilities associated with a jurisdiction based on a difference between the first set of liability events and the second set of liability events; and
allocate one or more debits or credits in association with the jurisdiction based on the difference.

17. The system of claim 16, wherein allocating one or more debits or credits in association with the jurisdiction comprises one or more of: extracting funds from a current pay stub of the employee, extracting funds from one or more pay stubs of the employee, issuing a correction pay stub at an end of a pay period to the employees, and issuing a settlement.

18. The system of claim 15, further containing instructions that cause the hardware processor to:
generating a differential timeline, the differential timeline representing a difference between the first timeline of liability events and the second timeline of liability events; and
providing the differential timeline for display on a user interface of a user device of the user

19. The system of claim 15, further containing instructions that cause the hardware processor to:
identify one or more tax liabilities associated with the second set of liability events, each tax liability associated with an amount owed to a jurisdiction; and
redistribute funds allocated to each of the jurisdictions based on the one or more tax liabilities.

20. The system of claim 15, further containing instructions that cause the hardware processor to:
access an employer timeline of liability events, the employer timeline associated with an employer of the employee;
identify one or more employer liability events based on the modified data; and
generate an updated employer timeline based on the employer timeline and the one or more employer liability events.
